(19) United States
(12) Patent Application Publication
(10) Pub. No.: US 2026/0197350 A1
(43) Pub. Date: Jul. 9, 2026

(54) SECURE FILE TRANSFER METHOD

(71) Applicant: DTC LLC, Soldotna, AK (US)

(72) Inventors: Robert Gilbreath, Soldotna, AK (US); William Lee, Soldotna, AK (US)

(21) Appl. No.: 19/009,069

(22) Filed: Jan. 3, 2025

(51) Int. Cl. H04L 9/40; H04L 67/06

(52) U.S. Cl. CPC H04L 63/166; H04L 63/0876; H04L 67/06

(57) ABSTRACT

A secure (i.e. modern authenticated) file transfer method that allows file transfer protocols without augmentation of the file transfer protocol is described. The secure file transfer method designates and transfer a file to an intended destination without further user intervention, with the creation of intermediate storage instances of the file transferred between the device and the cloud storage platform.

### BACKGROUND

Companies (i.e. entities) worldwide deal with the problem of converting physical documents into digital documents for storage in a way that allows for organization (i.e. the documents are organized into desired location in a digital environment, such as cloud storage), collaboration (i.e. the documents are accessible to members of an entity via the digital environment), and deduplication (i.e. the document is stored in the digital environment in a single location).

Conventional methods addressed this problem in two ways: (1) physical scanners convert physical documents into digital files, and (2) digital environments manage organization, deduplication, search, permissions, histories, and other features that enhance collaboration and digital file management. However, moving documents from the physical scanner to the digital environment remains cumbersome for businesses of all sizes.

There are three notable conventional methods for converting a physical document into a digital file stored in a cloud storage platform. The first conventional method includes scanning a physical document to a folder. In this conventional method, credentials for a file server or network attached storage (NAS) device are stored on the physical scanner and the destination folder is designated at the time of scan. A user at the entity then must manually upload the scanned file from the storage location to the cloud storage platform. This requires on-site physical scanners and multiple steps. Additionally, files of the physical documents accidentally left on the physical scanner can result in regulatory and compliancy violations, such as violations of the Health Insurance Portability and Accountability Act (HIPAA) and the Payment Card Industry (PCI) standards.

The second conventional method includes scanning to email. In this conventional method, credentials for an SMTP mailing account are stored on a physical scanner, and recipient(s) are designated at the time of scan. This is relatively quick but at medium-large entities it requires maintaining large recipient lists. The recipient then needs to take an extra step to manually transfer the file from their inbox to a cloud storage platform. Entities using this solution see mailbox bloat and unmanageability with even average scan volumes. In addition, files accidentally left in the inbox may result in regulatory and compliancy violations, when the email environment does not meet the regulatory security requirements.

The third conventional method is direct transfer of the file using an application installed on a multi-function printer (MFP). Because of modern authentication requirements for accessing cloud platforms, these apps require regular reauthorization, complex authentication procedures per scan session involving phone apps in combination with the device app, and other cumbersome barriers to use.

It is therefore desirable to have a secure (i.e. modern authenticated) file transfer method that allows file transfer protocols without augmentation of the file transfer protocol. If is further desirable for the secure file transfer method to designate and transfer the file to an intended destination without further user intervention. Finally, it is desirable for the secure file transfer method to not create intermediate storage instances of the file transferred between the device and the cloud storage platform.

### SUMMARY

In aspects, a method for secure file transfer from a device to a cloud storage platform, the method including receiving a request input to initiate a file transfer session, the request input having been transmitted from a device of a second computer system to a first computer system via a network, the request input configured to request the file transfer session to securely transfer and determine a façade, wherein the determination comprises a façade server of the first computer system identifying a file transfer protocol of the device and presenting the façade that aligns to the file transfer protocol; transmitting an acceptance output to accept the file transfer session, the acceptance output having been transmitted from the first computer system to the second computer system via the network, the acceptance output configured to accept and initiate the file transfer session using the file transfer protocol of the device; receiving an authentication input, the authentication input having been transmitted from the second computer system to the first computer system via the network, the authentication input configured for transmitting uploader and entity information encoded in the format of the file transfer protocol of the device; processing the uploader and entity information of the authentication input, wherein the processing comprises the façade server mapping the uploader and entity information to a uploader and entity pair format, where the façade server deploys an application programming interface (API) call to retrieve a password hash from a database of the first computer system associated with the uploader entity pair to authenticate the device; transmitting an authentication output based on successful authentication of the device, the authentication output being transmitted from the first computer system to the second computer system via the network, the authentication output configured to initiate transfer of a file from the device of the second computer system; receiving a file transfer input, the file transfer input having been transmitted from the device of the second computer system to the first computer system via the network, the file transfer input comprising the file and intent information, where the file transfer input is configured to store the file at a third computer system; processing the file transfer input, wherein the processing comprises determining a storage location at the third computer system based on the intent information, where the façade server maps intent and entity information to an intent and entity pair format to deploy an API call to retrieve location and credential information from the database that is associated with the intent and entity pair at the third computer system; transmitting a file storage initiation output, the file storage initiation output being transmitted from the first computer system to the third computer system via the network, where the file storage initiation output is configured to initiate a connection with the third computer system using an API and the credential information; receiving a file storage initiation input in response to successful authentication of the credential information, the file storage initiation input being transmitted from the third computer system to the first computer system, the file storage initiation input configured to establish a network connection with the first and third computer systems for file transfer; transmitting a file output, the file output being transmitted from the first computer system to the third computer system using the network connection via the network, the file output configured for storage at the third computer system in the location of the intent, wherein the file output comprises the file.

In aspects the method of paragraph [0007], wherein the file transfer protocol is server message block (SMB).

In aspects the method of paragraph [0008], wherein the uploader and entity information is encoded via device configuration of the device and in a server domain name of the device respectively, and wherein the intent and entity information is encoded in a tree connect request of the device and the server domain name respectively.

In aspects the method of paragraph [0007], wherein the file transfer protocol is simple mail transfer protocol (SMTP).

In aspects the method of paragraph [0010], wherein the uploader and entity information is encoded in an email address associated with the device as the username and domain, respectively, and wherein the intent and entity information is encoded in an email address of a recipient as the username and domain, respectively.

In aspects the method of paragraph [0008], wherein the file is a portable document format file.

In aspects the method of paragraph [0008], wherein the file is a tagged image file format file.

In aspects the method of paragraph [0010], wherein the file is a portable document format file.

In aspects the method of paragraph [0010], wherein the file is an electronic mail format file.

In aspects the method of paragraph [0008], wherein there is no intermediate of the file.

In aspects the method of paragraph [0010], wherein there is no intermediate storage of the file.

In aspects, a method for secure file transfer from a device to a cloud storage platform, the method including receiving a request input to initiate a file transfer session, the request input having been transmitted from a device of a second computer system to a first computer system via a network, the request input configured to request the file transfer session to securely transfer and determine a façade, wherein the determination comprises a façade server of the first computer system identifying a file transfer protocol of the device and presenting the façade that aligns to the file transfer protocol; transmitting an acceptance output to accept the file transfer session, the acceptance output having been transmitted from the first computer system to the second computer system via the network, the acceptance output configured to accept and initiate the file transfer session using the file transfer protocol of the device; receiving a file transfer and authentication input, the file transfer and authentication input having been transmitted from the second computer system to the first computer system via the network, the file transfer and authentication input configured for transmitting uploader, entity, and intent information encoded in the format of the file transfer protocol of the device and a file; processing the file transfer and authentication input to authenticate the device, wherein the processing comprises the façade server mapping the uploader and entity information to a uploader and entity pair format, where the façade server deploys an application programming interface (API) call to retrieve a password hash from a database of the first computer system associated with the uploader entity pair to authenticate the device; and upon successful authentication, determining a storage location at the third computer system based on the intent information, where the façade server maps intent and entity information to an intent and entity pair format to deploy an API call to retrieve location and credential information from the database that is associated with the intent and entity pair at the third computer system; transmitting a file storage initiation output, the file storage initiation output being transmitted from the first computer system to the third computer system via the network, where the file storage initiation output is configured to initiate a connection with the third computer system using an API and the credential information; receiving a file storage initiation input in response to successful authentication of the credential information, the file storage initiation input being transmitted from the third computer system to the first computer system, the file storage initiation input configured to establish a network connection with the first and third computer systems for file transfer; transmitting a file output, the file output being transmitted from the first computer system to the third computer system using the network connection via the network, the file output configured for storage at the third computer system in the location of the intent, wherein the file output comprises the file.

In aspects the method of paragraph [0018], wherein the file transfer protocol is T.30.

In aspects the method of paragraph [0018], wherein the file is a tagged image file format file.

In aspects the method of paragraph [0018], wherein the file is a picture exchange file.

In aspects the method of paragraph [0019], wherein there is no intermediate storage of the file.

In aspects the method of paragraph [0019], wherein the uploader and entity information is encoded in the telephone number of the device and a first QR code of the file, respectively, and wherein the intent and entity information is encoded in a second QR code of the file and the telephone number of the device, respectively.

### BRIEF DESCRIPTION OF THE FIGURES

FIG. 1 is a flow chart representing a method 100 for the secure file transfer method.

FIG. 2 is a block diagram 200 representing a system for implementing the method shown in FIG. 1.

FIG. 3 is a representation of the entity and intent information associated with a T.30 protocol transmission for receipt by a first computer system.

### DETAILED DESCRIPTION

“Basic authentication” means authenticating a device or a user using a conventional username and password combination that cloud storage platforms do not deploy as insecure.

“Modern authentication” means authenticating a device or a user using conventional methods of a username and password, where the password is a sufficient length and randomness, certificate, dual factor authentication, tokens, or passkeys that cloud storage platforms deploy as they are deemed sufficiently secure.

“Device” means a physical device having a processor and memory sufficient to deploy a file transfer protocol to transfer a file to a cloud storage platform using modern authentication. A device may be an MFP, a personal computer having a mail user agent, or a fax machine, or the like that can deploy basic authentication or modern authentication.

“Uploader” means information identifying the particular device deploying a file transfer protocol to send a file to a façade server.

“Intent” means the encoded destination for the file transferred using the secure file transfer method.

“Façade” means the software program deployed by the first computer system for a façade server to present as a component of the file transfer protocol. For example, for SMB the façade presents the server of the first computer system as an SMB server; for SMTP the façade presents the server of the first computer system as a Mail Submission Agent; for the fax receiver the façade presents the server of the first computer system as a fax endpoint.

“Cloud storage platform” means an application that is deployed across multiple computing devices to provide a mechanism for storing digital files that is accessed programmatically or via an API. Examples of cloud storage platforms include Google Docs, Azure blob storage, OneDrive, and Drop Box.

“Communication protocol” means a network protocol to transfer files via the network from the device to the cloud storage platform, such as SMB (server message block), SMTP (simple mail transfer protocol), and fax protocol (e.g. T.30).

A secure (i.e. modern authenticated) file transfer method that allows file transfer protocols without augmentation of the file transfer protocol is described. The secure file transfer method designates and transfer a file to an intended destination without further user intervention, with the creation of intermediate storage instances of the file transferred between the device and the cloud storage platform.

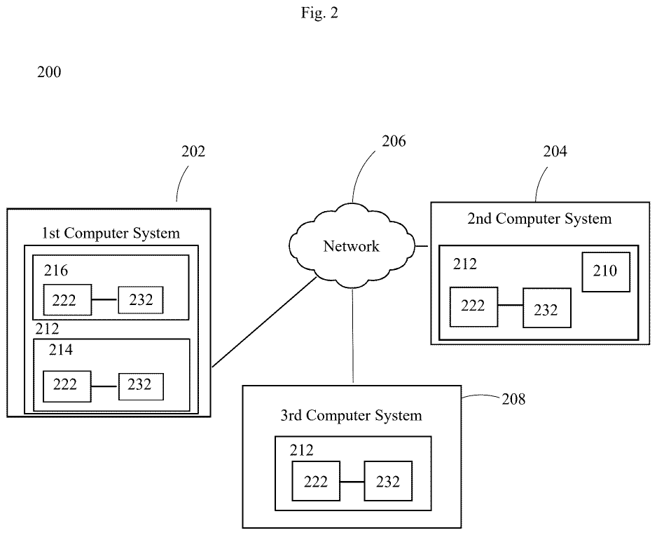

FIG. 2 is a block diagram of a system 200 for implementing a secure file transfer method. The system 200 may include a first computer system 202, a second computer system 204, and a third computer system 208. The secure file transfer method is provided as computer-based (e.g. online, web-based) services via a computing device associated with a provider of the services (e.g. service provider). A first computer system 202 is associated with the service provider. The first computer system 202 may include one or more computing devices 214 (e.g. servers, nodes, computers). As used herein, the “computing device” may refer to a general purpose device that can be programmed to carry out various sets of arithmetic or logical operations. Further, the computing device may include one or more processing elements 222 (e.g. processors, central processing unit (CPU)) and some form of memory 232 (e.g. data storage device, database), the memory being connected to (e.g. communicatively coupled with) the processing element(s). The computing device may further include one or more user interface devices (e.g. user input devices), such as a keyboard, mouse, display, and/or the like, which are connected to (e.g. communicatively coupled with) the processing element(s). As used herein, the term “server” may refer to software (and suitable computer hardware) which is configured for providing (or helping to provide) a network service. For example, the term “server” may refer to software which is executed on a dedicated computer (e.g. hosted by a networked computer) or executed on a computer in a shared hosting environment. Further, the term “server” may refer to the dedicated computer itself. Further, the term “server” may refer to a computer program which may execute to service the requests of other computer programs. When the first computer system 202 includes multiple computing devices, the multiple computing devices of the first computer system 202 may be connected to (e.g. communicatively coupled with) each other, including through the network or application program interfaces (APIs).

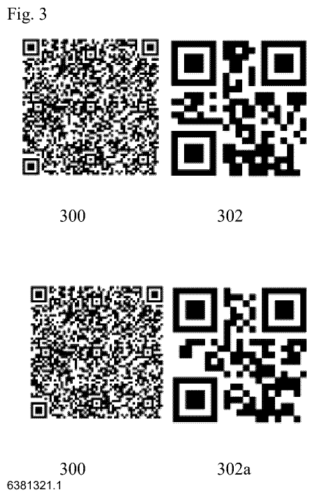

The first computer system 202, includes as one of the computing devices 212 one or more façade servers 216. The one or more façade servers 216 includes a programmatic architecture of the façade that permits the façade server 216 to communicate with devices 210 in a manner where the devices 210 recognize the façade server 216 as the particular destination server for the file transfer protocol. The façade deploys an algorithm for the façade server 216 to receive information from the device 210 using its standard transfer protocol and map information to an uploader/entity pair format and intent/entity pair format to process the information for use by the database 214 and transfer to the third computer system 208. When the façade server 216 is interacting with a device 210 using SMB, the façade receives and processes the information as an SMB server. The uploader information is encoded via configuration of the device, the entity information is encoded in the server domain name (e.g. [subdomain].[domain].[tld]) and the tree connect request (e.g. \\[entity]\[intent]). The intent information is encoded in the tree connect request (e.g. \\[entity]\[intent]). When the façade server 216 is interacting with a device 210 using SMTP, the façade receives and processes the information as an MSA. The uploader/entity information is encoded via the email address (e.g. [uploader]@[entity].[managed domain] that the device is configured to send information from. The intent/entity information is encoded in the recipient email address (e.g. [intent]@[entity].[managed domain]) selected by the user of the second computer system. When the façade server 216 is interacting with a device 210 using T.30 protocol, the façade receives and processes the information acting as a server deploying the T.30 protocol. The uploader information is the telephone number of the device 210, and the entity information is encoded via a first QR (quick response) code 300 (FIG. 3) that is included on a cover page of the transmission. The intent information is encoded via a second QR code 302 (FIG. 3) that is included on the cover page of the transmission. FIG. 3 shows a second set of QR codes 300 and 302a to demonstrate that the same device 210 using the T.30 protocol may send to different locations, as the intent information of the second QR code 302a is different from the first set of QR codes.

Further the first computer system 202, includes as one of the computing devices 212 a database 214 that is communicatively coupled to the façade server 216, such as, for example, through an API. The database 214 stores information in association with one or more entities including credentials for modern authentication with the third party computer system 208, the intent information of the third party computer system 208, and uploader information of the device 210, where the façade of the façade server 216 maps the uploader, entity, and intent information of the device 210 to the uploader/entity and intent/entity pair formats used in the process 100.

A second computer system 204 is associated with an entity (e.g. individual user, business, or the like) that desires to securely convert physical document to digital files (i.e. files) via the device 210 and transfer the files from the device 210 to its cloud storage of the third computer system 208 without any intermediary human involvement.

The second computer system 204 may include one or more computing devices (e.g. servers, nodes, computers) and has at least one device 210. The second computer system 204 may include multiple computing devices and devices 210, the multiple computing devices and device 210 of the second computer system 204 may be connected to (e.g. communicatively coupled with) each other. In examples, the second computer system 204 is remotely located from the first computer system 202.

The system may include a third computer system 208 that provides a cloud storage platform using modern authentication methods. For example, the third party computer system 208 may be associated with a third party providing cloud storage repository services that are accessible on a subscription basis. For example, the third party may be a share file site.

The third computer system 208 may include one or more computing devices (e.g. servers, nodes, computers). The third computer system 208 may include multiple computing devices, the multiple computing devices of the third computer system 208 may be connected to (e.g. communicatively coupled with) each other. For example, the third computer system 208 is remotely located from the first computer system 202 and second computer system 204 and connected to the first computer system 202 programmatically or via APIs.

The network 206 is configured for connecting the first computer system 202, the second computer system 204, including its devices 210, and the third computer system. The network 206 includes the internet and when the device is a fax sender the network 206 includes a public switched telephone network.

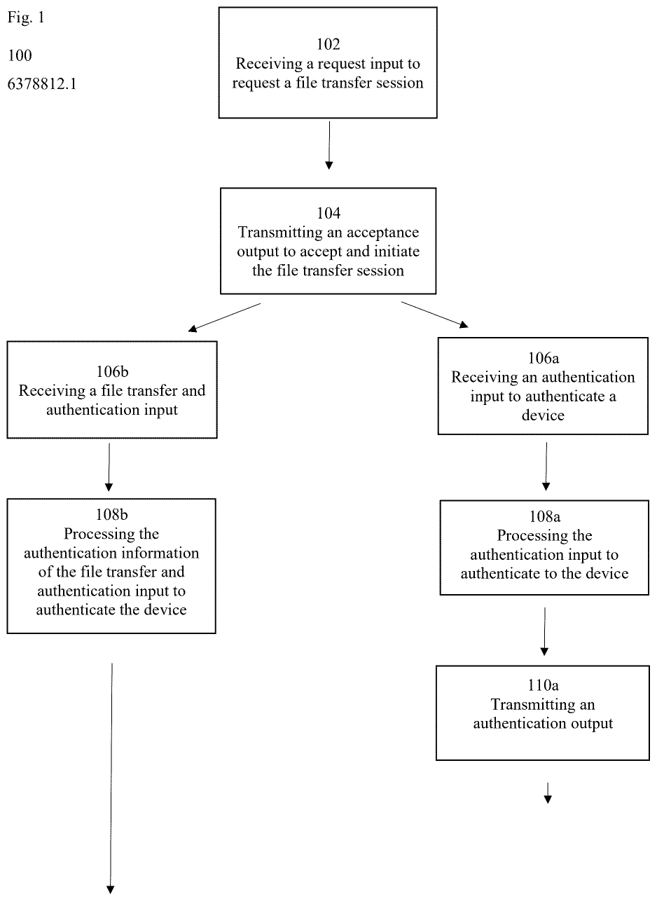

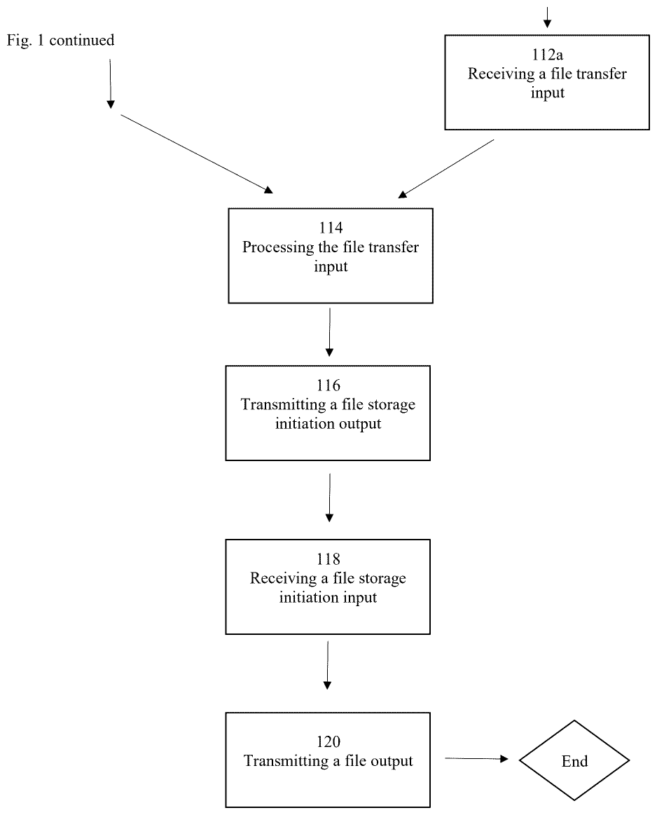

FIG. 1 represents a method 100 for secure file transfer from a device 210 to a cloud storage platform of the third computer system 208 without augmentation of the file transfer protocol, and without creating intermediate storage instances (i.e. the storage that occurs in the method 100 is not persistent storage, the storage that occurs in in the method 100 is storage in the RAM of the first computer system and that is written over upon completion of the secure file transfer) of the file transferred between the device 210 and the cloud storage platform of the third computer system 208. In 102, receiving a request input to initiate a file transfer session, the request input having been transmitted from the second computer system 204 to the first computer system 202 via the network 206. The request input is configured to request a file transfer session that is secure and aligns to a file transfer protocol of the device 210 associated with the second computer system 204. The request input is the façade determination of the façade server 216. For example, when the device is a MFP, the authentication mechanism is TLS (transport layer security) and the façade determination is based on the receipt of the request input from the MFP; when the device is a personal computer having a mail user agent (MUA) the authentication mechanism is SSL (secure sockets layer) and the façade determination is based on the receipt of the request input from a MUA; when the device is a fax receiver the authentication mechanism is the translation of the T.30 transmission to a T.38 transmission via a PTSN-IP gateway and the façade determination is based on the receipt of the request input from the fax receiver (i.e. dialing the phone number of the fax endpoint of the first computer system).

In 104, transmitting an acceptance output to accept the file transfer session, the acceptance output having been transmitted from the first computer system 202 to the second computer system 204 via the network 206. The acceptance output is configured to accept and initiate the file transfer session associated with the file transfer protocol of the device 210 associated with the second computer system 204. When the device 210 is capable of transmitting authentication and intent information outside of the file, then the acceptance output is configured to initiate the file transfer protocol by authenticating the device, which is indicated by 106a, 108a, 110a, and 112a of FIG. 1. When the device 210 is not capable of transmitting authentication and intent information outside of the file, then the acceptance output is configured to initiate the file transfer protocol by transferring the file, which is indicated by the 106b and 108b of FIG. 1.

In 106b, receiving a file transfer and authentication input, the file transfer and authentication input having been transmitted from the second computer system 204 to the first computer system 202 via the network 206. The file transfer and authentication input is configured for transmitting both (1) the uploader information and entity and intent information encoded in the file of the format of the file transfer protocol, for example, as described for the T.30 protocol in paragraphs [0037]-[0040] and (2) the file for transfer from the device 210, for example, when

the device 210 is a fax machine, the file may be PCX (picture exchange) or TIFF (tagged image file format), or another file format compatible with the T.30 protocol. The file transfer and authentication input is further configured to store the file at the third computer system 208.

In 108b, processing the authentication information of the file and authentication input to authenticate to the device 210. The processing includes the façade server 216 of the first computer system 202 mapping the uploader and entity information of the authentication input to an uploader/entity pair format. The processing further includes the façade server 216 deploying an API call to retrieve a password hash from the database 214 that is associated with the uploader/entity pair. The processing further includes the façade server 216 authenticating the device 210 with this password hash. In response to a successful authentication with the password hash, the processing further includes, processing the file transfer input at 114.

In 106a, receiving an authentication input, the authentication input having been transmitted from the second computer system 204 to the first computer system 202 via the network 206. The authentication input is configured for transmitting the uploader and entity information encoded in the format of the file transfer protocol, for example, as described for the SMB and SMTP protocols in paragraphs [0037]-[0040]. The uploader and entity information is used for authenticating the device 210 of the second computer system 204.

In 108a, in response to the authentication input of 106, processing the uploader and entity information of the authentication input to authenticate to the device 210. The processing includes the façade server 216 of the first computer system 202 mapping the uploader and entity information of the authentication input to an uploader/entity pair format. The processing further includes the façade server 216 deploying an API call to retrieve a password hash from the database 214 that is associated with the uploader/entity pair. The processing further includes the façade server 216 authenticating the device 210 with this password hash.

In 110a, transmitting an authentication output based upon a successful authentication processing in 108a, the authentication output being transmitted from the first computer system 202 to the second computer system 204 via the network 206. The authentication output is configured for initiating the file transfer from the device 210 of the second computer system 204. For example, when the device 210 uses the SMB file transfer protocol the authentication output establishes a tree connect path. When the device 210 uses the SMTP file transfer protocol the authentication output initiates a data transfer. These file transfer protocols permit encrypted transfer of the file transfer in 112.

In 112a, receiving the file transfer input, the file transfer input having been transmitted from the second computer system 204 to the first computer system 202 from the device 210. The file transfer input including the file for transfer from the device 210. The file transfer input also includes the intent information. For example, when the device 210 is a MFP the file may be a PDF (portable document format) or TIFF (tagged image file format) file, or another file type compatible with SMB file transfer protocol; when the device 210 is a personal computer having a mail user agent, the file may be an email (i.e. EML) or PDF file, or another file type compatible with SMTP file transfer protocol. The file transfer input is configured to store the file at the third computer system 208.

In 114, processing the file transfer input to determine the intent for storage at the third party computer system 208. Processing the file transfer input includes processing the intent information of the file transfer input to determine storage location at the third party computer system 208. The processing includes the façade server 216 of the first computer system 202 mapping the intent and entity information (the entity information of the authentication input of 206) to an intent/entity pair format. The processing further includes the façade server 216 deploying an API call to retrieve location and credential information from the database 214 that is associated with the intent/entity pair at the third computer system 208.

In 116, transmitting a file storage initiation output, the file storage initiation output being transmitted from the first computer system 202 to the third computer system 208. The file storage initiation output is configured to initiate a connection with the third computer system 208 to facilitate file storage using an API. The file storage initiation output includes the credential information to authenticate the entity establish a network connection to transfer files to the third computer system 208.

In 118, receiving a file storage initiation input in response to successful authentication of the credential information by the third party computer system 208, the file storage initiation input being transmitted from the third computer system 208 to the first computer system 202. The file storage initiation input is configured to establish the network connection between the first computer system 202 and the third party computer system 208 for file transfer.

In 120, transmitting a file output based upon the file storage initiation input, the file output being transmitted from the first computer system 202 to the third computer system 208 via the network connection. The file output includes the file for storage and the intent information. The file output is configured to store the file at the third computer system 208 in the location of the intent. The file is not intermediately stored at the first computer system 202 and is stored at the third computer system 208.

The façade server 216 of the method 100 provides a publicly available server that communicates with the device 210 using a file transfer protocol as though the façade server 216 comprised a normal instance of a destination server for that protocol (e.g. MSA for SMTP, file server for SMB), and after receiving the file the façade sever 216 closes the connection in compliance with the communication protocol being deployed by the façade with a success method, and simultaneously or nearly simultaneously transfers the file to the third computer system 208 utilizing the third computer system 208 cloud platform APIs to store the file rather than using normal data handling methods (e.g. email for SMTP, local storage for SMB).

Further the façade server 216 of the method 100 provides the uploader/entity and intent/entity information pairs to facilitate the device authentication, credential authentication, and intent without modification to the augment the device 210 capabilities.

1. A method for secure file transfer from a device to a cloud storage platform, the method comprising:
Receiving a request input to initiate a file transfer session, the request input having been transmitted from a device of a second computer system to a first computer system via a network, the request input configured to request the file transfer session to securely transfer and determine a façade, wherein the determination comprises
a façade server of the first computer system identifying a file transfer protocol of the device and presenting the façade that aligns to the file transfer protocol;
Transmitting an acceptance output to accept the file transfer session, the acceptance output having been transmitted from the first computer system to the second computer system via the network, the acceptance output configured to accept and initiate the file transfer session using the file transfer protocol of the device;
Receiving an authentication input, the authentication input having been transmitted from the second computer system to the first computer system via the network, the authentication input configured for transmitting uploader and entity information encoded in the format of the file transfer protocol of the device;
Processing the uploader and entity information of the authentication input, wherein the processing comprises
the façade server mapping the uploader and entity information to a uploader and entity pair format, where the façade server deploys an application programming interface (API) call to retrieve a password hash from a database of the first computer system associated with the uploader entity pair to authenticate the device;
Transmitting an authentication output based on successful authentication of the device, the authentication output being transmitted from the first computer system to the second computer system via the network, the authentication output configured to initiate transfer of a file from the device of the second computer system;
Receiving a file transfer input, the file transfer input having been transmitted from the device of the second computer system to the first computer system via the network, the file transfer input comprising the file and intent information, where the file transfer input is configured to store the file at a third computer system;
Processing the file transfer input, wherein the processing comprises
determining a storage location at the third computer system based on the intent information, where the façade server maps intent and entity information to an intent and entity pair format to deploy an API call to retrieve location and credential information from the database that is associated with the intent and entity pair at the third computer system;
Transmitting a file storage initiation output, the file storage initiation output being transmitted from the first computer system to the third computer system via the network, where the file storage initiation output is configured to initiate a connection with the third computer system using an API and the credential information;
Receiving a file storage initiation input in response to successful authentication of the credential information, the file storage initiation input being transmitted from the third computer system to the first computer system, the file storage initiation input configured to establish a network connection with the first and third computer systems for file transfer;
Transmitting a file output, the file output being transmitted from the first computer system to the third computer system using the network connection via the network, the file output configured for storage at the third computer system in the location of the intent, wherein the file output comprises the file.

2. The method of claim 1, wherein the file transfer protocol is server message block (SMB).

3. The method of claim 2, wherein the uploader and entity information is encoded via device configuration of the device and in a server domain name of the device respectively, and wherein the intent and entity information is encoded in a tree connect request of the device and the server domain name respectively.

4. The method of claim 1, wherein the file transfer protocol is simple mail transfer protocol (SMTP).

5. The method of claim 4, wherein the uploader and entity information is encoded in an email address associated with the device as the username and domain, respectively, and wherein the intent and entity information is encoded in an email address of a recipient as the username and domain, respectively.

6. The method of claim 2, wherein the file is a portable document format file.

7. The method of claim 2, wherein the file is a tagged image file format file.

8. The method of claim 4, wherein the file is a portable document format file.

9. The method of claim 4, wherein the file is an electronic mail format file.

10. The method of claim 2, wherein there is no intermediate of the file.

11. The method of claim 4, wherein there is no intermediate storage of the file.

12. A method for secure file transfer from a device to a cloud storage platform, the method comprising:
Receiving a request input to initiate a file transfer session, the request input having been transmitted from a device of a second computer system to a first computer system via a network, the request input configured to request the file transfer session to securely transfer and determine a façade, wherein the determination comprises
a façade server of the first computer system identifying a file transfer protocol of the device and presenting the façade that aligns to the file transfer protocol;
Transmitting an acceptance output to accept the file transfer session, the acceptance output having been transmitted from the first computer system to the second computer system via the network, the acceptance output configured to accept and initiate the file transfer session using the file transfer protocol of the device;
Receiving a file transfer and authentication input, the file transfer and authentication input having been transmitted from the second computer system to the first computer system via the network, the file transfer and authentication input configured for transmitting uploader, entity, and intent information encoded in the format of the file transfer protocol of the device and a file;
Processing the file transfer and authentication input to authenticate the device, wherein the processing comprises
the façade server mapping the uploader and entity information to a uploader and entity pair format, where the façade server deploys an application programming interface (API) call to retrieve a password hash from a database of the first computer system associated with the uploader entity pair to authenticate the device; and
upon successful authentication, determining a storage location at the third computer system based on the intent information, where the façade server maps intent and entity information to an intent and entity pair format to deploy an API call to retrieve location and credential information from the database that is associated with the intent and entity pair at the third computer system;
Transmitting a file storage initiation output, the file storage initiation output being transmitted from the first computer system to the third computer system via the network, where the file storage initiation output is configured to initiate a connection with the third computer system using an API and the credential information;
Receiving a file storage initiation input in response to successful authentication of the credential information, the file storage initiation input being transmitted from the third computer system to the first computer system, the file storage initiation input configured to establish a network connection with the first and third computer systems for file transfer;
Transmitting a file output, the file output being transmitted from the first computer system to the third computer system using the network connection via the network, the file output configured for storage at the third computer system in the location of the intent, wherein the file output comprises the file.

13. The method of claim 12, wherein the file transfer protocol is T.30.

14. The method of claim 12, wherein the file is a tagged image file format file.

15. The method of claim 12, wherein the file is a picture exchange file.

16. The method of claim 13, wherein there is no intermediate storage of the file.

17. The method of claim 13, wherein the uploader and entity information is encoded in the telephone number of the device and a first QR code of the file, respectively, and wherein the intent and entity information is encoded in a second QR code of the file and the telephone number of the device, respectively.
